(19) United States
(12) Patent Application Publication
(10) Pub. No.: US 2008/0206481 A1
(43) Pub. Date: Aug. 28, 2008

(54) SILICONE CONTACT LENSES WITH WRINKLED SURFACE

(75) Inventors: Robert M. Braun, Penfield, NY (US); Ravi Sharma, Fairport, NY (US)

Correspondence Address: Bausch & Lomb Incorporated, One Bausch & Lomb Place, Rochester, NY, 14604-2701, US

(73) Assignee: BAUSCH & LOMB INCORPORATED, Rochester, NY (US)

(21) Appl. No.: 12/035,586

(22) Filed: Feb. 22, 2008

Related U.S. Application Data
(60) Provisional application No. 60/891,575, filed on Feb. 26, 2007.

(51) Int. Cl. B05D 3/00; B01J 19/12

(52) U.S. Cl. 427/532; 216/94

(57) ABSTRACT

At least one of the surfaces of a silicone contact lens is a wrinkled surface, providing the contact lens surface with a desired topography. The wrinkled surface may include random ridges, either over the entire surface of the lens, or in a desired pattern on the surface of the lens. The wrinkled surface is formed by subjecting the surface to a high energy source.

This application claims the benefit of Provisional Patent Application No. 60/891,575 filed Feb. 26, 2007, which is incorporated by reference herein.

### FIELD OF THE INVENTION

This invention relates to a silicone contact lens wherein at least one of the surfaces is a wrinkled surface, providing the contact lens surface with a desired topography. Preferably, the wrinkled surface is provided as a silicate coating on the contact lens surface. Generally, the wrinkled surface comprises random ridges, either over the entire surface of the lens, or in a desired pattern on the surface of the lens.

### BACKGROUND

Contact lenses made from silicone materials can generally be subdivided into two major classes, namely hydrogels and non-hydrogels. Non-hydrogels do not absorb appreciable amounts of water; whereas, hydrogels can absorb and retain water in an equilibrium state. Hydrogels generally have a water content greater than about ten weight percent and more commonly between about fifteen to about eighty weight percent.

Silicone contact lenses may tend to have relatively hydrophobic, non-wettable surfaces. Thus, various publications disclose methods for rendering the surface of silicone contact lenses more hydrophilic to improve their biocompatibility or wettability by tear fluid in the eye. Examples include U.S. Pat. Nos.: 6,193,369; 4,143,949; 5,135,297; 5,726,733; 6,550,915; 6,213,604; 6,348,507; 6,630,243; 6,428,839; 6,200,626; 6,440,571; 6,599,559; 4,055,378; 4,122942; 4,214,014; U.S. Pat. Nos. 4,143,949; 4,632,844; 4,312,575; 5,326,584; 4,312,575; U.S. Pat. Nos. 4,632,844; 6,638,563; and 5,760,100; WO 01/34312; WO 04/060431; WO 95/04609 and US 2005-0045589. Examples of commercial silicone hydrogel contact lenses include: balafilcon A contact lenses, which include plasma-oxidized silicate surfaces; and lotrafilcon A contact lenses, which include plasma-deposited hydrocarbon coating surfaces.

It is important for contact lenses to be comfortable during wear. Also, it is important to avoid corneal edema, inflammation and other adverse effects resulting from contact lens wear, especially lenses intended for wearing for an extended period of time. Finally, in the case of contact lenses having a modified surface, it is important for the modified surface to be optically clear and able to withstand manufacturing process conditions such as hydration and autoclaving for sterilization, as well as cleaning or disinfection treatments performed by the contact lens wearer.

### SUMMARY OF THE INVENTION

The invention provides a silicone contact lens, wherein a surface of the lens is wrinkled and includes raised ridges. Preferably, a wrinkled surface is provided on a posterior surface of the contact lens, so as to facilitate fluid exchange between the lens and a cornea when the lens is worn.

The invention provides various methods of achieving the wrinkled surface. Generally, the method comprises subjecting a surface of a silicone contact lens to a high energy source to form a wrinkled surface including raised ridges. Suitable energy sources include a focused ion beam, electron beam or laser beam.

### DETAILED DESCRIPTION OF VARIOUS PREFERRED EMBODIMENTS

The present invention is advantageous for contact lenses made of a silicone-containing polymer, and especially for silicone hydrogel contact lenses intended for continuous wear for an extended period. Hydrogels are a well-known class of materials that comprise hydrated, cross-linked polymeric systems containing water in an equilibrium state. Such materials are usually prepared by polymerizing a mixture containing at least one silicone-containing monomer and at least one hydrophilic monomer. Either the silicone-containing monomer or the hydrophilic monomer may function as a cross-linking agent (a cross-linker being defined as a monomer having multiple polymerizable functionalities) or a separate cross-linker may be employed. Applicable silicone-containing monomeric units for use in the formation of silicone hydrogels are well known in the art and numerous examples are provided in U.S. Pat. Nos. 4,136,250; 4,153,641; 4,740,533; 5,034,461; 5,070,215; 5,260,000; 5,310,779; and 5,358,995.

Examples of applicable silicone-containing monomeric units include bulky polysiloxanylalkyl (meth)acrylic monomers. An example of bulky polysiloxanylalkyl (meth)acrylic monomers is represented by the following Formula I:

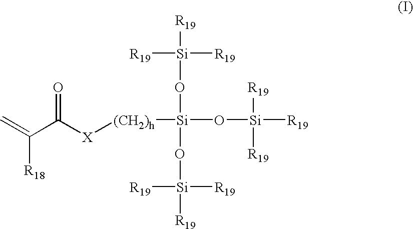

wherein:

X denotes —O— or —NR—;

each R₁₈ independently denotes hydrogen or methyl;

each R₁₉ independently denotes a lower alkyl radical, phenyl radical or a group represented by

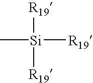

wherein each R_{19′} independently denotes a lower alkyl or phenyl radical; and

h is 1 to 10.

Some preferred bulky monomers are methacryloxypropyl tris(trimethylsiloxy)silane or tris(trimethylsiloxy)silylpropyl methacrylate, sometimes referred to as TRIS and tris(trimethylsiloxy)silylpropyl vinyl carbamate, sometimes referred to as TRIS-VC.

Such bulky monomers may be copolymerized with a silicone macromonomer, which is a poly(organosiloxane) capped with an unsaturated group at two or more ends of the molecule. U.S. Pat. No. 4,153,641 to Deichert et al. discloses, for example, various unsaturated groups, including acryloxy or methacryloxy.

Another class of representative silicone-containing monomers includes silicone-containing vinyl carbonate or vinyl carbamate monomers such as: 1,3-bis[4-vinyloxycarbonyloxy)but-1-yl]tetramethyl-disiloxane; 3-(trimethylsilyl)propyl vinyl carbonate; 3-(vinyloxycarbonylthio)propyl-[tris(trimethylsiloxy)silane]; 3-[tris(trimethylsiloxy)silyl]propyl vinyl carbamate; 3-[tris(trimethylsiloxy)silyl]propyl allyl carbamate; 3-[tris(trimethylsiloxy)silyl]propyl vinyl carbonate; t-butyldimethylsiloxyethyl vinyl carbonate; trimethylsilylethyl vinyl carbonate; and trimethylsilylmethyl vinyl carbonate.

Another class of silicone-containing monomers includes polyurethane-polysiloxane macromonomers (also sometimes referred to as prepolymers), which may have hard-soft-hard blocks like traditional urethane elastomers. Examples of silicone urethanes are disclosed in a variety or publications, including Lai, Yu-Chin, “The Role of Bulky Polysiloxanylalkyl Methacryates in Polyurethane-Polysiloxane Hydrogels,” Journal of Applied Polymer Science, Vol. 60, 1193-1199 (1996). PCT Published Application No. WO 96/31792 discloses examples of such monomers, which disclosure is hereby incorporated by reference in its entirety. Further examples of silicone urethane monomers are represented by Formulae II and III:

E(*D*A*D*G)a*D*A*D*E′; or (II)

E(*D*G*D*A)a*D*G*D*E′; (III)

wherein:

D denotes an alkyl diradical, an alkyl cycloalkyl diradical, a cycloalkyl diradical, an aryl diradical or an alkylaryl diradical having 6 to 30 carbon atoms;

G denotes an alkyl diradical, a cycloalkyl diradical, an alkyl cycloalkyl diradical, an aryl diradical or an alkylaryl diradical having 1 to 40 carbon atoms and which may contain ether, thio or amine linkages in the main chain;

denotes a urethane or ureido linkage;

a is at least 1;

A denotes a divalent polymeric radical of Formula IV:

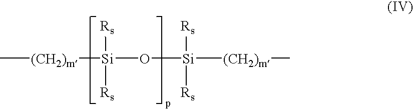

wherein:

each Rs independently denotes an alkyl or fluoro-substituted alkyl group having 1 to 10 carbon atoms which may contain ether linkages between carbon atoms;

m′ is at least 1; and

p is a number that provides a moiety weight of 400 to 10,000;

each of E and E′ independently denotes a polymerizable unsaturated organic radical represented by Formula V:

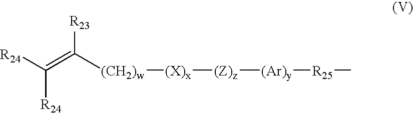

wherein:

R₂₃ is hydrogen or methyl;

R₂₄ is hydrogen, an alkyl radical having 1 to 6 carbon atoms, or a —CO—Y—R₂₆ radical wherein Y is —O—, —S— or —NH—;

R₂₅ is a divalent alkylene radical having 1 to 10 carbon atoms;

R₂₆ is a alkyl radical having 1 to 12 carbon atoms;

X denotes —CO— or —OCO—;

Z denotes —O— or —NH—;

Ar denotes an aromatic radical having 6 to 30 carbon atoms;

w is 0 to 6; xis 0 or 1; y is 0 or 1; and z is 0 or 1.

A representative silicone-containing urethane monomer is represented by Formula (VI):

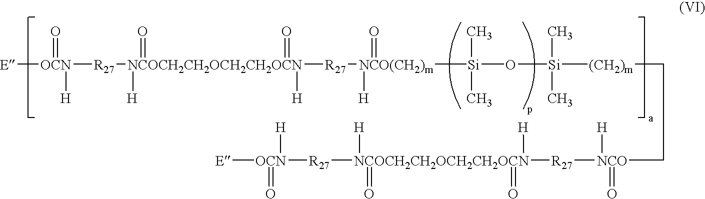

wherein m is at least 1 and is preferably 3 or 4, a is at least 1 and preferably is 1, p is a number which provides a moiety weight of 400 to 10,000 and is preferably at least 30, R₂₇ is a diradical of a diisocyanate after removal of the isocyanate group, such as the diradical of isophorone diisocyanate, and each E″ is a group represented by:

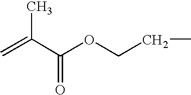

Another class of representative silicone-containing monomers includes fluorinated monomers. Such monomers have been used in the formation of fluorosilicone hydrogels to reduce the accumulation of deposits on contact lenses made therefrom, as described in U.S. Pat. Nos. 4,954,587, 5,079,319 and 5,010,141. The use of silicone-containing monomers having certain fluorinated side groups, i.e. —(CF₂)—H, have been found to improve compatibility between the hydrophilic and silicone-containing monomeric units, as described in U.S. Pat. Nos. 5,387,662 and 5,321,108.

In one preferred embodiment of the invention, a silicone hydrogel material comprises (in bulk, that is, in the monomer mixture that is copolymerized) 5 to 50 percent, preferably 10 to 25, by weight of one or more silicone macromonomers, 5 to 75 percent, preferably 30 to 60 percent, by weight of one or more polysiloxanylalkyl (meth)acrylic monomers, and 10 to 50 percent, preferably 20 to 40 percent, by weight of a hydrophilic monomer. Examples of hydrophilic monomers include, but are not limited to, ethylenically unsaturated lactam-containing monomers such as N-vinyl pyrrolidinone, methacrylic and acrylic acids; acrylic substituted alcohols, such as 2-hydroxyethylmethacrylate and 2-hydroxyethylacrylate and acrylamides, such as methacrylamide and N,N-dimethylacrylamide, vinyl carbonate or vinyl carbamate monomers such as disclosed in U.S. Pat. Nos. 5,070,215, and oxazolinone monomers such as disclosed in U.S. Pat. No. 4,910,277. Other hydrophilic monomers will be apparent to one skilled in the art.

Silicone elastomer contact lenses are formed of a silicone elastomer, such as various polydimethylsiloxane materials. In contrast to silicone hydrogel copolymers, silicone elastomers are more rubbery and hydrophobic, generally lack a hydrophilic co-monomer, and do not absorb appreciable amounts of water.

The above silicone materials are merely exemplary, and other materials for use as substrates that can benefit by this invention have been disclosed in various publications and are being continuously developed for use in contact lenses and other medical devices. For illustrative purposes, the following description focuses on silicone hydrogel copolymers, although various aspects of the invention are applicable for silicone elastomer contact lens materials.

Some monomer mixtures for silicone hydrogels include an organic diluent in the initial monomeric mixture that is unreactive with the monomeric components. Suitable organic diluents include, for example, monohydric alcohols, with C₆-C₁₀ straight-chained aliphatic monohydric alcohols such as n-hexanol and n-nonanol being especially preferred; diols such as ethylene glycol; polyols such as glycerin; ethers such as diethylene glycol monoethyl ether; ketones such as methyl ethyl ketone; esters such as methyl enanthate; and hydrocarbons such as toluene. Generally, the diluent when present is included at five to sixty percent by weight of the initial monomeric mixture, with ten to fifty percent by weight being especially preferred. The diluent may be removed from the contact lens, after casting, by evaporation and/or exchange with an extracting solvent.

Other additives commonly employed in the silicone hydrogel monomer mixture include polymerization initiators, tints, and UV absorbing agents, among others.

The initial monomer mixture is polymerized to form a copolymer. Contact lenses may be manufactured by various conventional techniques, to yield a shaped article having the desired posterior and anterior lens surfaces. As examples, spincasting methods are known, including those disclosed in U.S. Pat. Nos. 3,408,429 and 3,660,545; and static casting methods are known, including those disclosed in U.S. Pat. Nos. 4,197,266 and 5,271,875. Generally, static cast molding involves dispensing the liquid monomer mixture in the mold cavity of a mold assembly including a posterior mold part and an anterior mold part, the posterior mold part including an optical mold surface for forming the posterior contact lens surface, and the anterior mold part including an optical mold surface for forming the anterior contact lens surface. Then, while the monomer mixture is in this mold cavity, the monomer mixture is exposed to thermal energy and/or light energy to cure the monomer mixture and form the copolymer.

According to conventional contact lens manufacturing, the cast contact lens is removed from the mold assembly. The contact lens is typically extracted with a solvent to remove any unrelated monomers or other undesired materials from the cast lens; an organic solvent, such as isopropyl alcohol, water, or an aqueous solution may be used for extraction. The lens is hydrated and packaged in an aqueous solution, whereby the silicone hydrogel copolymer absorbs and retains water, and the packaged contact lens is typically sterilized, such as by autoclaving.

For the methods of this invention, the cast contact lens may be removed from the mold assembly prior to treating the lens. Alternately, the cast contact lens may be retained on a mold part, where one surface of the lens is exposed for treatment. Generally, the lens will be treated by the methods of this invention subsequent to casting of the lens, and prior to a final hydration of the silicone hydrogel copolymer.

This invention provides at least one surface of the contact lens with a wrinkled surface. Both the posterior and anterior surfaces of the contact lens may have this wrinkled surface, or only one of the surfaces may be wrinkled. Additionally, if desired, only selected portions of the posterior and/or anterior surfaces may be wrinkled. According to preferred embodiments, the posterior surface of the lens is wrinkled so as to facilitate improved fluid exchange between the posterior surface of the lens and the cornea while the lens is worn.

The wrinkled surface generally includes a series of raised ridges with depressions therebetween, wherein the raised ridges have heights of 0.5 to 1000 nm with respect to such depressions. More preferably, the raised ridges have heights of 10 to 600 nm with respect to such adjacent depressions. The raised ridges will generally be randomly interspersed. Individual raised ridges may have various shapes, such as circular, cylindrical or curved shapes.

Various contact lens publications seek to achieve a smoother surface, under the theory that a smoother surface will be more comfortable. In contrast, the present invention provides a contact lens with a more textured surface, the textured surface not compromising comfort but providing the contact lens surface with a desired texture, such as to provide the improved fluid exchange between the contact lens and the cornea.

According to the method of the invention, at least a portion of the surface of a silicone-containing contact lens is subjected to a high energy source, such as a focused ion beam, electron beam or laser beam. The surface of the lens should be bombarded by the energy source to a depth of at least 5 nm, but not through the entire bulk of the lens, as it is desired to modify the surface region relative to the bulk. The interaction of the energy sources will lead to disruption of the polymer backbone in this near-surface region, for example, via bond breaking and possibly bond formation along the polymer chains. This alteration will create lattice mismatches between the surface and bulk regions of the lens that will lead to the desired wrinkling of the surface.

The focused ion and electron beams may possess energies between 500 eV and several hundred keV, but preferably will be between 10 keV and 30 keV. Continuous or pulsed laser beams operating in the nanosecond to sub-femtosecond regimes may be utilized to accomplish this same goal. In this case, power densities, spot sizes and exposure times are optimized, depending on the specific lens material, to achieve the desired degree of wrinkling at the surface relative to the bulk lens substrate. Based on the degree of alteration as well as the depth of penetration of the energetic sources, which may be optimized by adjusting current densities and incident energies, it is possible to create layered or nested regions each possessing different wrinkled patterns. The resultant coating is a wrinkled, robust coating that does not delaminate from the contact lens surface.

For any of the aforementioned methods, portions of the contact lens surface may be masked during treatment, such that the masked portions exhibit less wrinkling than the unmasked portions.

Optionally, the wrinkled surface of the contact lens may be further modified, such as by grafting or plasma-deposition of a material to the surface. For example, a coating of a hydrophilic polymer may be deposited on one or more surfaces of the contact lens.

It will be appreciated that various combinations of surface characteristics may be employed. As one specific example, the posterior side of the lens is treated so that the posterior silicate surface layer becomes wrinkled, thus providing a textured surface for fluid exchange when the lens is worn. In contrast, the anterior side of the lens is left untreated, so that the anterior surface has no wrinkling; a hydrophilic polymeric coating or other coating may be applied to the anterior surface.

### EXAMPLE 1

Table 1 discloses a monomer mixture for forming a silicone hydrogel lens material useful for the present invention.

TABLE 1

| Component | Parts by Weight |
|---|---|
| TRIS-VC | 55 |
| NVP | 30 |
| V₂D₂₅ | 15 |
| VINAL | 1 |
| n-nonanol | 15 |
| Darocur initiator | 0.2 |
| tint agent | 0.05 |

The following materials are designated above:

| | |
|---|---|
| TRIS-VC | tris(trimethylsiloxy)silylpropyl vinyl carbamate |
| NVP | N-vinyl pyrrolidone |
| V₂D₂₅ | a silicone-containing vinyl carbonate as previously |
| | described in U.S. Pat. No. 5,534,604. |
| VINAL | N-vinyloxycarbonyl alanine |
| Darocur | Darocur-1173, a UV initiator |
| tint agent | 1,4-bis[4-(2-methacryloxyethyl)phenylamino] |
| | anthraquinone |

### EXAMPLE 2

Table 2 discloses a monomer mixture for forming a polyurethane silicone hydrogel formulation useful in the present invention.

TABLE 2

| Component | Parts by Weight | |
|---|---|---|
| ID3S4H | 55 | |
| TRIS | 20 | |
| DMA | 25 | |
| UV Absorber | 0.5 | |
| n-Hexanol | 20 | |
| Irgacure-819 initiator | 0.5 | |
| Tint agent | 150 | ppm |

The following materials are designated above:

| | |
|---|---|
| TRIS | tris(trimethylsiloxy)silylpropyl methacrylate |
| DMA | N,N-dimethylacrylamide |
| ID3S4H | a polysiloxane-containing urethane |
| | prepolymer of Formula (VI) where R₂₇ is |
| | the residue of isophorone diisocyanate, and |
| | having a molecular weight about 4000. |
| Irgacure-819 | a UV initiator |

### EXAMPLE 3

Table 3 discloses a monomer mixture for forming a polyfumarate silicone hydrogel formulation useful in the present invention.

TABLE 3

| Component | Parts by Weight | |
|---|---|---|
| F₂D₂₀ | 20 | |
| TRIS | 40 | |
| DMA | 40 | |
| n-Hexanol | 5 | |
| Darocur initiator | 0.5 | |
| Tint Agent | 150 | ppm |

The following materials are designated above:

| | |
|---|---|
| TRIS | tris(trimethylsiloxy)silylpropyl methacrylate |
| DMA | N,N-dimethylacrylamide |
| F₂D₂₀ | a silicone-containing crosslinking resin as |
| | previously described in U.S. Pat. Nos. 5,374,662 |
| | and 5,496,871. |

### EXAMPLE 4

This Example illustrates a process for forming silicone hydrogel contact lenses for a method of this invention. The monomer mixture of Table 2 was injected onto a clean polypropylene anterior mold half and covered with the complementary polypropylene posterior mold half. The mold halves were compressed, and the mixture was cured by exposure to UV radiation. The top mold half was removed, and the lenses were maintained in a forced air oven to remove the majority of the n-hexanol diluent. The lenses are removed from the bottom mold half, extracted in isopropanol, and then dried.

### EXAMPLE 5

The lenses are subjected to ion and electron beams with energies between 10 keV and 30 keV. Power density, spot size and exposure time are selected to achieve the desired degree of wrinkling at the surface relative to the bulk lens substrate.

It will be understood that various modifications may be made to the embodiments disclosed herein. Therefore the above description should not be construed as limiting, but merely as exemplifications of preferred embodiments. Other arrangements and methods may be implemented by those skilled in the art without departing from the scope and spirit of this invention. Moreover, those skilled in the art will envision other modifications within the scope and spirit of the features and advantages appended hereto.

We claim:

1. A method comprising:
subjecting a surface of a silicone contact lens to a high energy source to form a wrinkled surface including raised ridges.

2. The method of claim 1, wherein the energy source is selected from a focused ion beam, electron beam or laser beam.

3. The method of claim 1, wherein the contact lens is comprised of a silicone hydrogel copolymer.

4. The method of claim 1, wherein a posterior surface of the contact lens is provided with the wrinkled surface.

5. The method of claim 1, wherein the raised ridges have heights of 0.5 to 1000 nm.

6. The method of claim 5, wherein the raised ridges have heights of 10 to 600 nm.

7. The method of claim 1, wherein the wrinkled surface covers an entire surface of the contact lens.

8. The method of claim 1, wherein the wrinkled surface covers a selected portion of a contact lens surface.

9. The method of claim 1, further comprising depositing a coating on the wrinkled surface.

10. The method of claim 1, wherein one lens surface is wrinkled and the other lens surface comprises a coating deposited thereon.
